(19) United States
(12) Patent Application Publication
(10) Pub. No.: US 2011/0298774 A1
(43) Pub. Date: Dec. 8, 2011

(54) DISPLAY APPARATUS

(75) Inventors: Takaharu Yamada, Osaka (JP); Yasunao Iwata, Osaka (JP); Kuniko Maeno, Osaka (JP); Yasuhiro Mimura, Osaka (JP); Tomoo Furukawa, Osaka (JP); Hideki Morii, Osaka (JP); Tetsuya Fujikawa, Osaka (JP)

(73) Assignee: Sharp Kabushiki Kaisha, Osaka-shi ,Osaka (JP)

(21) Appl. No.: 13/138,437

(22) PCT Filed: Oct. 9, 2009
(86) PCT No.: PCT/JP2009/067607

§ 371 Date: Aug. 16, 2011

(30) Foreign Application Priority Data
Mar. 18, 2009 (JP) 2009-066174

(51) Int. Cl. G09G 5/00

(52) U.S. Cl. 345/211; 345/87

(57) ABSTRACT

An LUT fixedly stores correction values to compensate for a pull-in voltage in pixels in a liquid crystal panel. In at least one example embodiment, the display control unit outputs an input video signal Xa, a video signal Xp of a previous frame read from a frame memory, and a pixel polarity indicating a polarity of a pixel applied voltage on the pixel basis, and outputs a correction value read from the LUT to a data line driving circuit as a video signal Xb after correction. The data line driving circuit performs alternate current driving, based on the video signal Xb after correction. The LUT stores different correction values between when a positive polarity voltage is applied and when a negative polarity voltage is applied, for at least a part of combinations of values of the input video signal Xa and the video signal Xp of the previous frame. This can reduce a difference in response speed between when the positive polarity voltage is applied and when the negative polarity voltage is applied, thereby enhancing display quality.

### TECHNICAL FIELD

The present invention relates to a display apparatus, and particularly to a display apparatus that switches a polarity of a voltage applied to a pixel with a predetermined cycle.

### BACKGROUND ART

In a liquid crystal display apparatus, since continuously applying a voltage of the same polarity to a pixel causes a defect such as image persistence, alternate current driving in which the polarity of the voltage applied to the pixel (hereinafter, referred to as a pixel applied voltage) is switched with a predetermined cycle is performed. For example, line inversion driving in which the polarity of the pixel applied voltage is switched on the basis of one or a plurality of gate lines, source-line inversion driving in which the polarity of the pixel applied voltage is switched on the basis of one or a plurality of data lines, dot inversion driving in which the polarity of the pixel applied voltage is switched on the basis of one pixel, or the like is performed.

Moreover, it is known that in the pixel of the liquid crystal display apparatus, when a thin film transistor (hereinafter, referred to as a TFT for short) in the pixel changes from an ON state to an OFF state, the pixel applied voltage falls by a predetermined amount. For example, in a pixel 3 shown in FIG. 3 (described later), a difference between a drain voltage of a TFT 4 and a common electrode voltage Vcom is the pixel applied voltage. When a gate voltage of the TFT 4 changes from a high level to a low level, the pixel applied voltage falls by an amount in accordance with a capacitance value of a parasitic capacitance 7 existing between a gate and a drain of the TFT 4, and the like. The fall amount at this time is referred to as a pull-in voltage or a feed-through voltage.

If the alternate current driving is performed without any consideration of the influence of the pull-in voltage, a difference is caused in an effective value of the pixel applied voltage between when a positive polarity voltage is applied (hereinafter, referred to as at the time of positive polarity), and when a negative polarity voltage is applied (hereinafter, referred to as at the time of negative polarity), which causes flicker on a screen. As a method for preventing the flicker, there is known a method in which the common electrode voltage Vcom is adjusted so that the effective values of the pixel applied voltage at the time of positive polarity and at the time of negative polarity are equal. Moreover, there is also known a method in which a voltage corrected for the pull-in voltage is generated in a data line driving circuit to apply the voltage after the correction to the data line.

Concerning the present invention, the following prior art documents are known. In Patent Document 1, there is described a liquid crystal display apparatus including a frame memory 91 that stores gradation data of a previous frame and a correction circuit 92 in order to make response time of liquid crystal almost constant, as shown in FIG. 18. When input gradation data is larger than stored gradation data, the correction circuit 92 outputs correction gradation data as display gradation corresponding to the input gradation data one frame time later to a liquid crystal driver 93, and when the input gradation data is smaller than the stored gradation data, the correction circuit 92 outputs the input gradation data to the liquid crystal driver 93.

In Patent Document 2, there is described a display apparatus including a correction circuit that performs correction of overshooting or undershooting a luminance so that an average luminance reaches a target luminance, and makes a correction signal smaller or larger depending on which is larger between a gradation level of an input gradation signal of a current frame and that of a previous frame, even when the luminance necessary for the correction is the same. In Patent Document 3, there is described a liquid crystal display apparatus that performs overshoot driving using two tables. In Patent Document 4, there is described a liquid crystal display apparatus that controls a degree of the overshoot in accordance with polarity of a voltage applied to a data line to perform line inversion driving.

### PRIOR ART DOCUMENTS

### Patent Documents

[Patent Document 1] Japanese Patent Gazette No. 2708746
[Patent Document 2] Japanese Patent Gazette No. 3769463
[Patent Document 3] Japanese Patent Gazette No. 3958161
[Patent Document 4] International Publication Pamphlet No. WO 2007/91353

### SUMMARY OF THE INVENTION

### Problems to be Solved by the Invention

The liquid crystal display apparatus has a problem that when a moving picture is displayed, flicker, a stripe pattern, a granular pattern and the like occur, thereby degrading display quality. As one of causes of this problem, the difference in response speed of a liquid crystal between at the time of positive polarity and at the time of negative polarity is cited. For example, when the pixel applied voltage changes in the pixel 3 shown in FIG. 3, a permittivity of the liquid crystal changes and the capacitance value of the liquid crystal capacitance 5 also changes. Moreover, depending on the capacitance value of the liquid crystal capacitance 5 at a point when the TFT 4 changes to the OFF state, the pull-in voltage is affected by the pixel applied voltage in the previous frame time. Thus, if the alternate current driving is performed without any consideration of the influence by the pixel applied voltage in the previous frame time, the luminance of the pixel will not reach a predicted level one frame time later, so that the difference in response speed may be caused between at the time of positive polarity and at the time of negative polarity. The presence of the above-described difference in response speed results in flicker and the like on the display screen, thereby degrading the display quality.

An object of the present invention is therefore to provide a display apparatus that has a small difference in response speed between at the time of positive polarity and at the time of negative polarity, and high display quality.

### Means for Solving the Problems

According to a first aspect of the present invention, there is provided a display apparatus including: a display panel including a plurality of pixels each including a thin film transistor; a correction unit that performs, to an input video signal, correction to compensate for fall of a pixel applied voltage caused by a parasitic capacitance existing between a gate and a drain of the thin film transistor; a driving unit that applies a voltage in accordance with a video signal obtained by the correction unit to each of the pixels in the display panel while switching a polarity; and a storage unit that stores data obtained at the time of correction to a video signal of a previous frame as reference data, wherein the correction unit performs different corrections in accordance with the polarity of the pixel applied voltage, based on the input video signal and the reference data read from the storage unit for at least a part of combinations of both values thereof.

According to a second aspect of the present invention, in the first aspect of the present invention, the display apparatus further includes a table that fixedly stores correction values relating to the input video signal in association with the combinations of the values of the input video signal and the reference data, wherein the correction unit performs the correction to the input video signal, using the correction value read from the table, and the table stores the different correction values in accordance with the polarity of the pixel applied voltage for at least a part of the combinations of the values of the input video signal and the reference data.

According to a third aspect of the present invention, in the second aspect of the present invention, the storage unit stores the video signal of the previous frame as the reference data.

According to a fourth aspect of the present invention, in the second aspect of the present invention, the storage unit stores reached gradation one frame time later as the reference data.

According to a fifth aspect of the present invention, in the fourth aspect of the present invention, the table fixedly stores the reached gradation one frame time later in association with the combinations of the values of the input video signal and the reference data.

According to a sixth aspect of the present invention, in the first aspect of the present invention, the display apparatus further includes a frame rate conversion unit that performs processing of generating a plurality of sub-frames based on one image to the input video signal, and outputs the obtained video signal to the correction unit.

According to a seventh aspect of the present invention, in the first aspect of the present invention, the display panel further includes a plurality of gate lines used for selection of the pixels, and the driving unit applies a voltage having the same polarity to the plurality of pixels connected to the same gate line.

According to an eighth aspect of the present invention, in the first aspect of the present invention, the display panel further includes a plurality of gate lines used for selection of the pixels, and the driving unit applies a positive polarity voltage and a negative polarity voltage in a mixed manner to the plurality of pixels connected to the same gate line.

According to a ninth aspect of the present invention, in the first aspect of the present invention, for at least a part of the combinations of the values of the input video signal and the reference data, the correction unit performs the correction to make the pixel applied voltage higher when an absolute value of the pixel applied voltage becomes larger than that of the previous frame, and to make the pixel applied voltage lower when the absolute value of the pixel applied voltage becomes smaller than that of the previous frame.

According to a tenth aspect of the present invention, in the first aspect of the present invention, for at least a part of the combinations of the values of the input video signal and the reference data, the correction unit performs the correction to change a gradation value in the same direction as change from the previous frame when a positive polarity voltage is applied, and to change the gradation value in the reverse direction to the change from the previous frame when a negative polarity voltage is applied.

According to an eleventh aspect of the present invention, in the first aspect of the present invention, the display panel is a liquid crystal panel including a plurality of pixels each further including a liquid crystal capacitance and an auxiliary capacitance, the liquid crystal panel including the plurality types of pixels, in which at least one of capacitance values of the liquid crystal capacitance, the auxiliary capacitance, and the parasitic capacitance is different, and the correction unit performs different corrections to the input video signal in accordance with the type of the pixel.

According to a twelfth aspect of the present invention, in the eleventh aspect of the present invention, the display panel includes a plurality of types of pixels different in cell gap.

According to a thirteenth aspect of the present invention, there is provided a driving method of a display apparatus having a display panel including a plurality of pixels each including a thin film transistor, the method including the steps of: performing, to an input video signal, correction to compensate for fall of a pixel applied voltage caused by a parasitic capacitance existing between a gate and a drain of the thin film transistor; applying a voltage in accordance with a corrected video signal to each of the pixels in the display panel while switching a polarity; and storing data obtained at the time of correction to a video signal of a previous frame as reference data, wherein in the step of performing the correction, different corrections are performed in accordance with the polarity of the pixel applied voltage, based on the input video signal and the stored reference data for at least a part of combinations of both values thereof.

### Effects of the Invention

According to the first or thirteenth aspect of the present invention, the correction to the input video signal is performed in order to compensate for the fall of the pixel applied voltage caused by the parasitic capacitance existing between the gate and the drain of the thin film transistor. When this correction for the pull-in voltage is performed, the different corrections are performed in accordance with the polarity of the pixel applied voltage, based on the reference data obtained at the time of correction to the video signal of the previous frame, which enables the correction to be performed precisely even when the input video signal changes. Accordingly, the luminance of the pixel one frame time later can be made uniform between when the positive polarity voltage is applied and when the negative polarity voltage is applied, and a difference in response speed between both can be resolved. This can prevent flicker and the like from occurring on the display screen, thereby enhancing display quality.

According to the second aspect, the table that fixedly stores the correction values relating to the input video signal in association with the combinations of the values of the input video signal and the reference data is provided, which enables the correction value necessary for the correction for the pull-in voltage to be obtained with ease.

According to the third aspect of the present invention, the video signal of the previous frame is used as the reference data, which enables the difference in response speed between when the positive polarity voltage is applied and when the negative polarity voltage is applied to be resolved, thereby enhancing the display quality in a relatively small circuit amount.

According to the fourth aspect of the present invention, the reached gradation one frame time later is used as the reference data, which enables the difference in response speed between when the positive polarity voltage is applied and when the negative polarity voltage is applied to be resolved at high accuracy, thereby further enhancing the display quality.

According to the fifth aspect of the present invention, the table that fixedly stores the correction values relating to the input video signal and the reached gradation one frame time later is provided, which enables the reached gradation one frame time later necessary for the correction for the pull-in voltage to be obtained with ease.

According to the sixth aspect of the present invention, in the display apparatus that performs the processing of generating the plurality of sub-frames based on one image, the difference in response speed between when the positive polarity voltage is applied and when the negative polarity voltage is applied can be resolved, so that the display quality can be enhanced.

According to the seventh aspect of the present invention, as in line inversion driving, in the display apparatus that applies the voltage having the same polarity to the plurality of pixels connected to the same gate line, the difference in response speed between when the positive polarity voltage is applied and when the negative polarity voltage is applied can be resolved, so that the display quality can be enhanced.

According to the eighth aspect of the present invention, as in dot inversion driving and source line inversion driving, in the display apparatus that applies the positive polarity voltage and the negative polarity voltage in a mixed manner, to the plurality of pixels connected to the same gate line, the difference in response speed between when the positive polarity voltage is applied and when the negative polarity voltage is applied can be resolved, so that the display quality can be enhanced.

According to the ninth aspect of the present invention, when the absolute value of the pixel applied voltage becomes larger than that of the previous frame, the correction to increase the pixel applied voltage is performed in view of the larger pull-in voltage, and when the absolute value of the pixel applied voltage becomes smaller than that of the previous frame, the correction to decrease the pixel applied voltage is performed in view of the smaller pull-in voltage, which enables the correction to be performed precisely, even when the input video signal changes. Accordingly, the difference in response speed between when the positive polarity voltage is applied and when the negative polarity voltage is applied can be resolved, so that the display quality can be enhanced.

According to the tenth aspect of the present invention, when the positive polarity voltage is applied, the gradation value is changed in the same direction as the change from the previous frame, and when the negative polarity voltage is applied, the gradation value is changed in the reverse direction to the change from the previous frame, which enables the correction to be performed precisely even when the input video signal changes. Accordingly, the difference in response speed between when the positive polarity voltage is applied and when the negative polarity voltage is applied can be resolved, so that the display quality can be enhanced.

According to the eleventh aspect of the present invention, in the case where the liquid crystal panel in which the capacitance value of the capacitance in the pixel differs depending on the type of the pixel is used, the different corrections are also performed in accordance with the type of the pixel when the correction for the pull-in voltage is performed, which enables the difference in response speed between when the positive polarity voltage is applied and when the negative polarity voltage is applied to be resolved for all the types of pixels, thereby enhancing the display quality.

According to the twelfth aspect of the present invention, in the case where the liquid crystal panel in which the capacitance value of the capacitance in the pixel differs because a cell gap differs depending on the type of pixel is used, the different corrections are also performed in accordance with the type of the pixel when the correction for the pull-in voltage is performed, which enables the difference in response speed between when the positive polarity voltage is applied and when the negative polarity voltage is applied to be resolved for all the types of pixels, thereby enhancing the display quality.

### BRIEF DESCRIPTION OF THE DRAWINGS

FIG. 1 is a block diagram showing a configuration of a liquid crystal display apparatus according to a first embodiment of the present invention.

FIG. 2 is a layout diagram of a liquid crystal panel of the liquid crystal display apparatus shown in FIG. 1.

FIG. 3 is a circuit diagram of a pixel included in the liquid crystal panel of the liquid crystal display apparatus shown in FIG. 1.

FIG. 4 is a diagram showing a relationship between a pixel applied voltage and a liquid crystal permittivity in the pixel shown in FIG. 3.

FIG. 5 is a diagram showing a relationship between the pixel applied voltage and a pull-in voltage in the pixel shown in FIG. 3.

FIG. 6 is a diagram showing change in drain voltage of a TFT in a pixel and change in pixel capacitance in a liquid crystal panel in a normally white mode.

FIG. 7 is a diagram showing change in drain voltage of a TFT in a pixel and change in pixel capacitance in a liquid crystal panel in a normally black mode.

FIG. 8 is a diagram showing change in luminance level in a conventional liquid crystal display apparatus.

FIG. 9 is a diagram showing change in luminance level in the liquid crystal display apparatus shown in FIG. 1.

FIG. 10 is a block diagram showing a configuration of a liquid crystal display apparatus according to a second embodiment of the present invention.

FIG. 11 is a block diagram showing a configuration of a liquid crystal display apparatus according to a third embodiment of the present invention.

FIG. 12 is a diagram showing a frame rate conversion processing in the liquid crystal display apparatus shown in FIG. 11.

FIG. 13 is a diagram showing a converter included in a liquid crystal display apparatus according to a fifth embodiment of the present invention.

FIG. 14A is a waveform diagram showing change in pixel applied voltage when black display is continuously performed in a liquid crystal display apparatus according to a sixth embodiment of the present invention.

FIG. 14B is a waveform diagram showing change in the same voltage when white display is continuously performed.

FIG. 14C is a waveform diagram showing change in the same voltage when white display of positive polarity and black display of negative polarity are alternately performed.

FIG. 14D is a waveform diagram showing change in the same voltage when black display of positive polarity and white display of negative polarity are alternately performed.

FIG. 15A is a waveform diagram showing change in pixel applied voltage when white display is continuously performed in a liquid crystal display apparatus according to a seventh embodiment of the present invention.

FIG. 15B is a waveform diagram showing change in the same voltage when black display is continuously performed.

FIG. 15C is a waveform diagram showing change in the same voltage when black display of positive polarity and white display of negative polarity are alternately performed.

FIG. 15D is a waveform diagram showing change in the same voltage when white display of positive polarity and black display of negative polarity are alternately performed.

FIG. 16 is a block diagram showing a configuration of a liquid crystal display apparatus according to an eighth embodiment of the present invention.

FIG. 17 is a cross-sectional view of a liquid crystal panel of the liquid crystal display apparatus shown in FIG. 16.

FIG. 18 is a block diagram showing a configuration of a conventional liquid crystal display apparatus.

### MODE FOR CARRYING OUT THE INVENTION

### First Embodiment

FIG. 1 is a block diagram showing a configuration of a liquid crystal display apparatus according to a first embodiment of the present invention. A liquid crystal display apparatus 10 shown in FIG. 1 includes a display control unit 11, a frame memory 12, a look up table (hereinafter, referred to as an LUT) 13, a gate line driving circuit 14, a data line driving circuit 15, and a liquid crystal panel 16. The liquid crystal display apparatus 10 corrects an input video signal Xa in the display control unit 11, and displays an image on the liquid crystal panel 16 by performing alternate current driving, based on a video signal Xb after the correction.

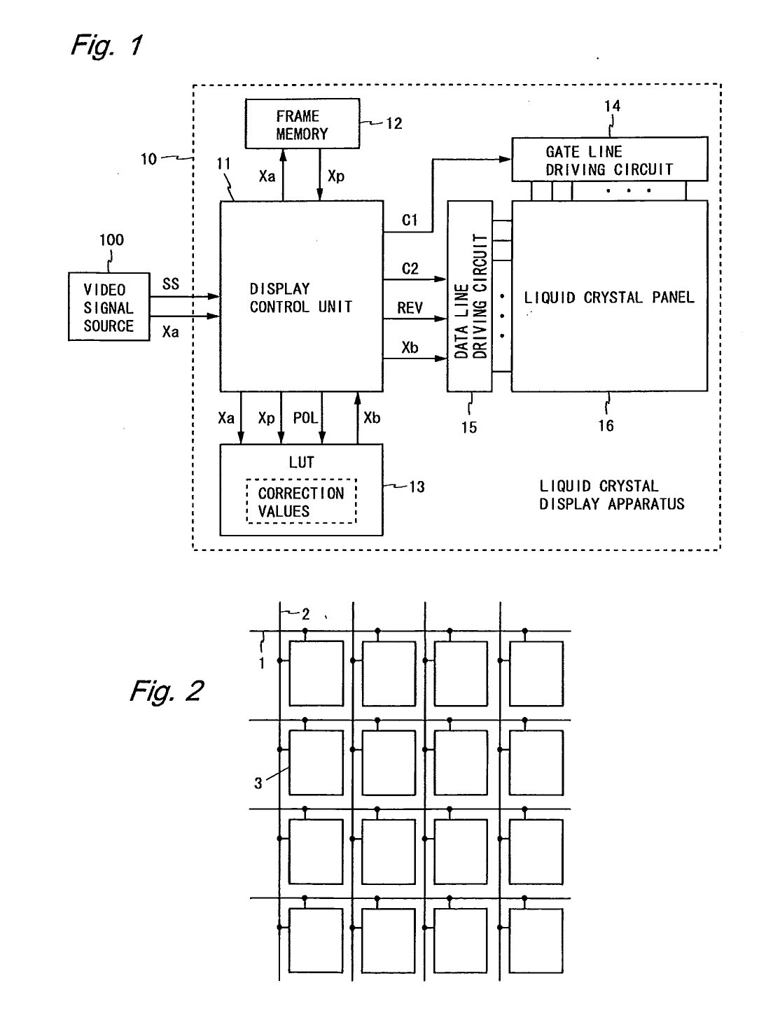

FIG. 2 is a layout diagram of the liquid crystal panel 16. As shown in FIG. 2, in the liquid crystal panel 16, a plurality of gate lines 1, a plurality of data lines 2, and the plurality of pixels 3 are formed. The gate lines 1 are arranged parallel to one another, the data lines 2 are arranged parallel to one another so as to be orthogonal to the gate lines 1. The pixels 3 are arranged two-dimensionally, corresponding to intersection points of the gate lines 1 and the data lines 2. The gate lines 1 are referred to as scanning signal lines as well, and the data lines 2 are referred to as source lines or video signal lines as well.

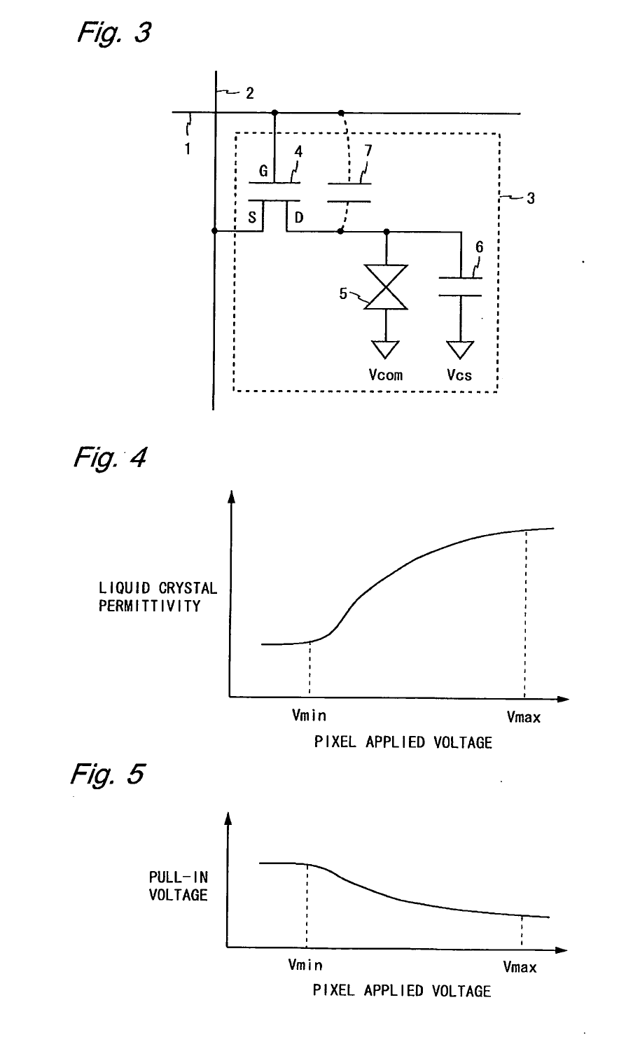

FIG. 3 is a circuit diagram of the pixel 3. As shown in FIG. 3, the pixel 3 includes a TFT 4, a liquid crystal capacitance 5 and an auxiliary capacitance 6. A gate electrode of the TFT 4 is connected to a gate line 1, and a source electrode is connected to the data line 2. A drain electrode of the TFT 4 is connected to one electrode of the liquid crystal capacitance 5 and one electrode of the auxiliary capacitance 6. A common electrode voltage Vcom is applied to another electrode of the liquid crystal capacitance 5, and an auxiliary capacitance voltage Vcs at the same level as that of the common electrode voltage Vcom is applied to another electrode of the auxiliary capacitance 6. In the pixel 3, a parasitic capacitance 7 exists between the gate electrode and the drain electrode of the TFT 4, and a difference between a drain voltage of the TFT 4 and the common electrode voltage Vcom is a pixel applied voltage.

The TFT 4 serves as a switching element that switches whether or not a voltage is to be written to the pixel 3. When the voltage is to be written to the pixel 3, a voltage higher than a threshold voltage of the TFT 4 is applied to the gate line 1 and a voltage in accordance with the video signal is applied to the data line 2. At this time, since the TFT 4 turns to an ON state, the drain voltage of the TFT 4 becomes equal to the voltage applied to the data line 2, and electric charge of an amount in accordance with the pixel applied voltage at this point is accumulated in the liquid crystal capacitance 5 and the auxiliary capacitance 6.

Thereafter, a voltage lower than the threshold voltage of the TFT 4 is applied to the gate line 1 to switch the TFT 4 to an OFF state. Since the parasitic capacitance 7 exists in the pixel 3, when the TFT 4 changes from an ON state to the OFF state, the pixel applied voltage falls by an amount indicated in the following equation (1).

ΔVd=Vgₚ₋ₚ×Cgd/(Clc+Ccs+Cgd) (1)

Note that in equation (1) Vgₚ₋ₚ, is a change amount of a gate voltage of the TFT 4, Clc is a capacitance value of the liquid crystal capacitance 5, Ccs is a capacitance value of the auxiliary capacitance 6, and Cgd is a capacitance value of the parasitic capacitance 7. In the case where a parasitic capacitance other than the parasitic capacitance 7 is considered, a capacitance value thereof may be added in the parenthesis of the equation (1).

Thereafter, until the TFT 4 again turns to the ON state, the pixel applied voltage is maintained at almost the same level. A luminance of the pixel in this period is determined by the pixel applied voltage. Accordingly, writing the voltage in accordance with the input video signal Xa to all the pixels 3 in the liquid crystal panel 16 enables a predetermined image to be displayed on the liquid crystal panel 16.

Hereinafter, referring to FIG. 1, a configuration and operation of the liquid crystal display apparatus 10 will be described. The display control unit 11 is a control circuit that controls the whole of the liquid crystal display apparatus 10. The frame memory 12 is a memory that stores the input video signal Xa of at least one frame. The LUT 13 is a table that stores correction values of the input video signal Xa fixedly in advance. The gate line driving circuit 14 and the data line driving circuit 15 are driving circuits of the liquid crystal panel 16.

A video signal source 100 that outputs a synchronization signal SS and the input video signal Xa is provided outside the liquid crystal display apparatus 10. The synchronization signal SS and the input video signal Xa output from the video signal source 100 are input to the display control unit 11. The display control unit 11 outputs a control signal C1 to the gate line driving circuit 14 and outputs a control signal C2 to the data line driving circuit 15, based on the synchronization signal SS. In the control signal C1, a gate start pulse, a gate clock and the like are included, and in the control signal C2, a source start pulse, a source clock and the like are included. Moreover, the display control unit 11 outputs a line polarity REV indicating a polarity of the pixel applied voltage on the line basis to the data line driving circuit 15. Furthermore, the display control unit 11 performs correction to the input video signal Xa to compensate for a pull-in voltage, and outputs the video signal Xb after the correction to the data line driving circuit 15. The frame memory 12 and the LUT 13 are provided to perform this correction. to be displayed on the liquid crystal panel 16.

Hereinafter, referring to FIG. 1, a configuration and operation of the liquid crystal display apparatus 10 will be described. The display control unit 11 is a control circuit that controls the whole of the liquid crystal display apparatus 10. The frame memory 12 is a memory that stores the input video signal Xa of at least one frame. The LUT 13 is a table that stores correction values of the input video signal Xa fixedly in advance. The gate line driving circuit 14 and the data line driving circuit 15 are driving circuits of the liquid crystal panel 16.

A video signal source 100 that outputs a synchronization signal SS and the input video signal Xa is provided outside the liquid crystal display apparatus 10. The synchronization signal SS and the input video signal Xa output from the video signal source 100 are input to the display control unit 11. The display control unit 11 outputs a control signal C1 to the gate line driving circuit 14 and outputs a control signal C2 to the data line driving circuit 15, based on the synchronization signal SS. In the control signal C1, a gate start pulse, a gate clock and the like are included, and in the control signal C2, a source start pasuru, a source clock and the like are included. Moreover, the display control unit 11 outputs a line polarity REV indicating a polarity of the pixel applied voltage on the line basis to the data line driving circuit 15. Furthermore, the display control unit 11 performs correction to the input video signal Xa to compensate for a pull-in voltage, and outputs the video signal Xb after the correction to the data line driving circuit 15. The frame memory 12 and the LUT 13 are provided to perform this correction.

The gate line driving circuit 14 drives the gate lines 1 of the liquid crystal panel 16, based on the control signal C1. More particularly, the gate line driving circuit 14 sequentially selects one gate line from the plurality of gate lines 1 in accordance with the control signal C1, so that the voltage higher than the threshold voltage of the TFT 4 is applied to the selected gate line, and the voltage lower than the threshold voltage of the TFT 4 is applied to the other gate lines. The data line driving circuit 15 drives the data lines 2 of the liquid crystal panel 16, based on the control signal C2, the line polarity REV and the video signal Xb after the correction. More particularly, the data line driving circuit 15 generates voltages corresponding to the video signal Xb after the correction, and applies the generated voltages to the data lines 2. At this time, the data line driving circuit 15 switches the polarity of the generated voltages to the positive polarity and the negative polarity in accordance with the line polarity REV.

The display control unit 11 writes the input video signal Xa to the frame memory 12, and reads the written video signal one frame time later. Hereinafter, the video signal read from the frame memory 12 is referred to as a “video signal Xp of a previous frame”. The display control unit 11 reads the video signal Xp of the previous frame from the frame memory 12 while writing the input video signal Xa to the frame memory 12 as a video signal of a current frame in each frame time. Moreover, the display control unit 11 outputs the input video signal Xa, the video signal Xp of the previous frame, and a pixel polarity POL indicating the polarity of the pixel applied voltage on the pixel basis to the LUT 13, and outputs the correction value read from the LUT 13 to the data line driving circuit 15 as the video signal Xb after the correction.

The LUT 13 stores the correction values of the input video signal Xa fixedly in advance in association with combinations of a gradation value of the input video signal Xa, a gradation value of the video signal Xp of the previous frame, and the value of the pixel polarity POL. For example, when the input video signal Xa is a 256 gradation video signal, up to (256×256×2) correction values are stored in the LUT 13.

If the gradation value of the input video signal Xa is Ra and the gradation value of the video signal Xp of the previous frame is Rp, the correction value corresponding to the combination of these gradation values is decided by the following method, for example. First, based on the gradation values Ra, Rp and the value of the pixel polarity POL, determination is made whether the pixel applied voltage is to be higher or to be lower in order to compensate for the pull-in voltage. If the pixel applied voltage is to be higher, the correction value is decided so that the pixel applied voltage is higher by an amount indicated in the following equation (2). If the pixel applied voltage is to be lower, the correction value is decided so that the pixel applied voltage is lower by the amount by the following equation (2).

ΔVd=Vgₚ₋ₚ×Cgd/(Clc(P)+Ccs+Cgd) (2)

Note that Clc(P) included in the equation (2) is the capacitance value of the liquid crystal capacitance 5 when the previous frame is displayed.

For example, the correction value when white display is performed after black display is decided so that the pixel applied voltage is higher or lower by an amount indicated in an equation (3). The correction value when the black display is performed after the white display is decided so that the pixel applied voltage is higher or lower by an amount indicated in an equation (4).

ΔVd=Vgₚ₋ₚ×Cgd/(Clc(B)+Ccs+Cgd) (3)

ΔVd=Vgₚ₋ₚ×Cgd/(Clc(W)+Ccs+Cgd) (4)

Note that Clc (B) included in the equation (3) is the pixel applied voltage at the time of black display, and Clc(W) included in the equation (4) is the pixel applied voltage at the time of white display. In this manner, the correction value stored in the LUT 13 is decided so that the pixel applied voltage changes in accordance with the video signal of the previous frame.

In this manner, in the liquid crystal display apparatus 10, the display control unit 11 serves as a correction unit that performs the correction to compensate for the pull-in voltage (i.e., the correction to compensate for the fall of the pixel applied voltage caused by the parasitic capacitance 7) to the input video signal Xa. The frame memory 12 serves as a storage unit that stores, as reference data, the data (input video signal Xa in the present embodiment) obtained at the time of correction to the video signal of the previous frame. The LUT 13 serves as a table that fixedly stores the correction values relating to the input video signal Xa in association with the combinations of the value of the input video signal Xa and the reference data. The gate line driving circuit 14 and the data line driving circuit 15 serve as a driving unit that applies, to the respective pixels 3 in the liquid crystal panel 16, the voltage in accordance with the video signal obtained by the correction unit (the video signal Xb after the correction) while switching the polarity.

A liquid crystal display apparatus that performs a correction for the pull-in voltage in the data line driving circuit has been conventionally known. The data line driving circuit of the conventional liquid crystal display apparatus changes the pixel applied voltage in accordance with the video signal of the current frame. For example, the conventional data line driving circuit changes the pixel applied voltage by an amount indicated in an equation (5).

ΔVd=Vgₚ₋ₚ×Cgd/(Clc(A)+Ccs+Cgd) (5)

Note that Clc(A) included in the equation (5) is the capacitance value of the liquid crystal capacitance 5 when the current frame is displayed.

Hereinafter, referring to FIGS. 4 to 9, effects of the liquid crystal display apparatus 10 according to the present embodiment will be described. FIG. 4 is a diagram showing a relationship between the pixel applied voltage and a liquid crystal permittivity in the pixel 3. FIG. 5 is a diagram showing a relationship between the pixel applied voltage and the pull-in voltage in the pixel 3. As shown in FIGS. 4 and 5, as the pixel applied voltage becomes higher, the liquid crystal permittivity becomes larger, and the pull-in voltage becomes lower.

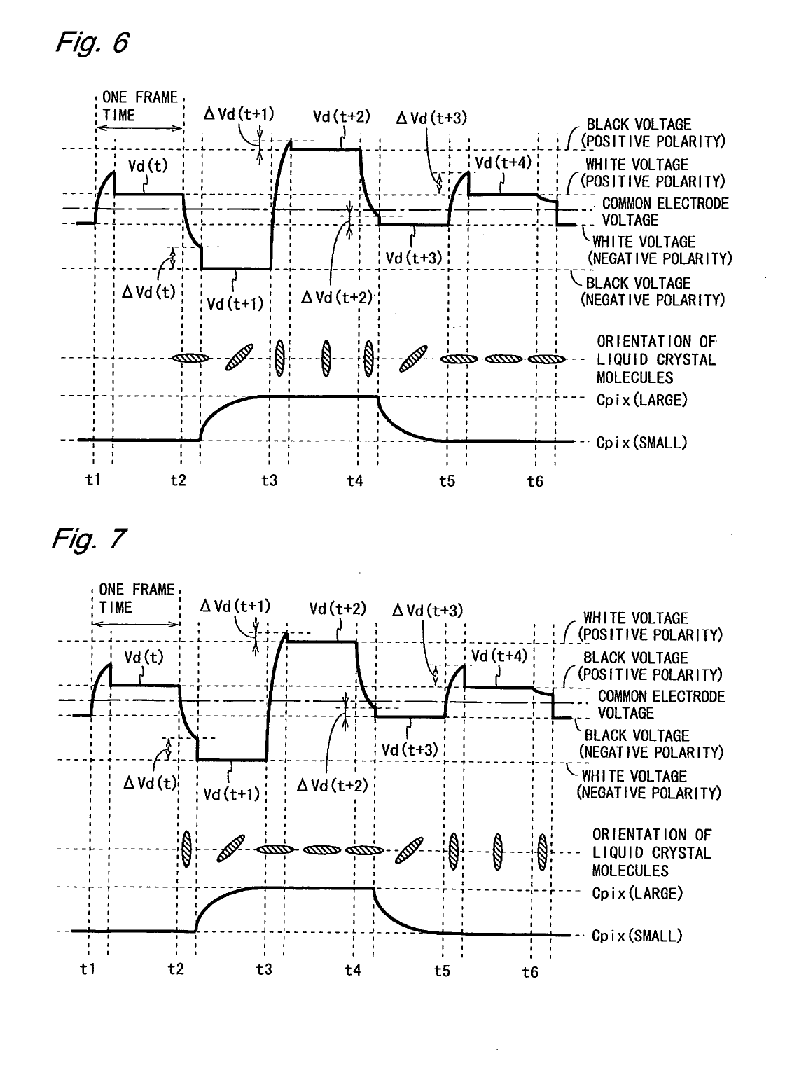

FIG. 6 is a diagram showing change in drain voltage of a TFT in a pixel and change in pixel capacitance in a liquid crystal panel in a normally white mode. FIG. 7 is a diagram showing the same contents in a liquid crystal panel in a normally black mode. The pixel capacitance is a total of capacitance values of the capacitances in the pixel 3 (the liquid crystal capacitance 5, the auxiliary capacitance 6 and the parasitic capacitance 7). In FIGS. 6 and 7, frame time starting at a time ti (i=1 to 6) is referred to as “i-th frame time”.

As shown in upper stages in FIGS. 6 and 7, a positive polarity voltage higher than the common electrode voltage and a negative polarity voltage lower than the common electrode voltage are alternately written to the pixel. In FIG. 6, a voltage for white display (hereinafter, referred to as a white voltage) is written in first, fourth, and fifth frame time, and a voltage for black display (hereinafter, referred to as a black voltage) is written in second and third frame time. In FIG. 7, the black voltage is written in the first, fourth and fifth frame time, and the white voltage is written in the second and third frame time.

In the liquid crystal panel in the normally white mode (FIG. 6), an absolute value of the pixel applied voltage at the time of black display is larger than that at the time of white display. Since as the absolute value of the pixel applied voltage is larger, the pixel capacitance is larger (refer to FIG. 4), the pixel capacitance is larger in the second and third frame time when the black display is performed. However, since even if the pixel applied voltage changes sharply, orientation of liquid crystal molecules changes slowly, the pixel capacitance also changes slowly. As shown in a lower stage of FIG. 6, the pixel capacitance gradually increases in the second frame time, and gradually decreases the same in the fourth frame time.

When the TFT 4 changes from the ON state to the OFF state, the pixel applied voltage falls by the pull-in voltage indicated in the equation (1). The capacitance value Clc included in the equation (1) is the capacitance value of the liquid crystal capacitance 5 at the point when the TFT 4 changes to the OFF state. When the input video signal Xa changes between the previous frame and the current frame, the capacitance value Clc is closer to the capacitance value when the previous frame is displayed than the capacitance value when the current frame is displayed.

Thus, in the second frame time, the pixel applied voltage, being affected by the white display in the previous frame time, falls large (the pull-in voltage is large). In the third frame time, the pixel applied voltage, being affected by the black display in the previous frame time, falls small (the pull-in voltage is small). Similarly, in the fourth frame time, the pixel applied voltage falls small, and in the fifth frame time, the pixel applied voltage falls large.

As described above, the conventional liquid crystal display apparatus changes the pixel applied voltage in accordance with the video signal of the current frame. Therefore, for example, in the second frame time when the black display is performed, the pull-in voltage is underestimated, so that the pixel applied voltage is corrected small, although it is preferable to correct the same large. Moreover, in the fourth frame time when the white display is performed, the pull-in voltage is overestimated, so that the pixel applied voltage is corrected large, although it is preferable to correct the same small. The same holds true for the liquid crystal panel in the normally black mode (FIG. 7).

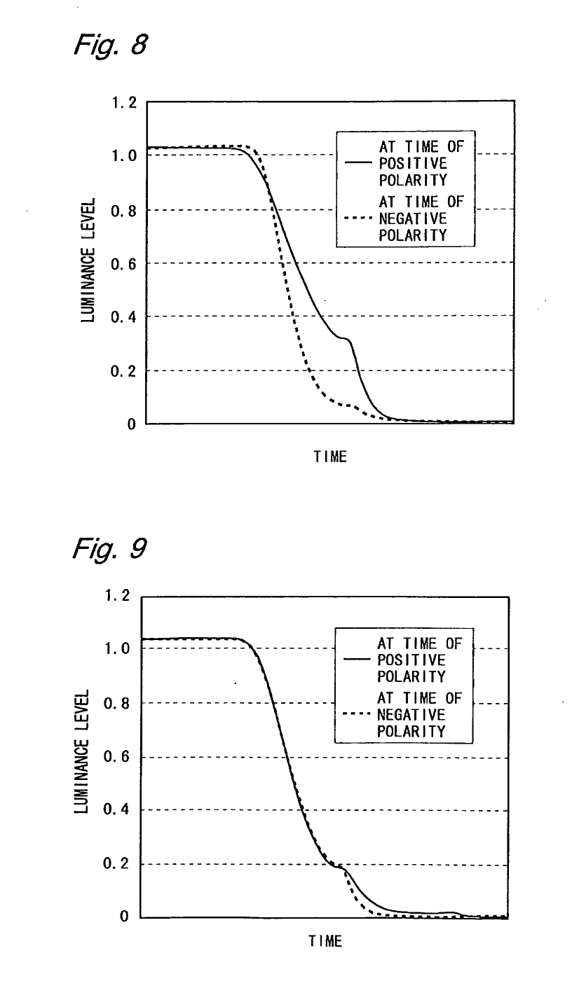

In this manner, in the conventional liquid crystal display apparatus, when the input video signal Xa changes between the previous frame and the current frame, the correction for the pull-in voltage cannot be performed precisely. As shown in FIG. 8, this causes a difference in reached level of the luminance of the pixel one frame time later between at the time of positive polarity and at the time of negative polarity, thereby causing a difference in response speed between at the time of positive polarity and at the time of negative polarity. This presence of the difference in response speed causes flicker and the like on the display screen, thereby degrading the display quality.

In contrast, in the liquid crystal display apparatus 10 according to the present embodiment, the pixel applied voltage is changed in accordance with the video signal Xp of the previous frame. Thus, for example, in the second frame time, the pull-in voltage is estimated large because the white display is performed in the previous frame time, so that the pixel applied voltage is corrected large. Moreover, in the fourth frame time, the pull-in voltage is estimated small because the black display is performed in the previous frame, so that the pixel applied voltage is corrected small. The same holds true for the liquid crystal panel in the normally black mode (FIG. 7).

In this manner, in the liquid crystal display apparatus 10, even when the input video signal Xa changes between the previous frame and the current frame, the correction for the pull-in voltage can be performed precisely. As shown in FIG. 9, this makes the reached level of the luminance of the pixel one frame time later equal between at the time of positive polarity and at the time of negative polarity, thereby enabling the difference in response speed to be resolved between at the time of positive polarity and at the time of negative polarity. Accordingly, flicker and the like can be prevented from occurring on the display screen, thereby enhancing the display quality.

As described above, in the liquid crystal display apparatus 10 according to the present embodiment, in order to compensate for the fall of the pixel applied voltage caused by the parasitic capacitance 7 existing between the gate and the drain of the TFT 4, the correction to the input video signal Xa is performed. When this correction for the pull-in voltage is performed, with the video signal Xp of the previous frame used as the reference data, different corrections are performed in accordance with the polarity of the pixel applied voltage based on the reference data, by which even when the input video signal Xa changes, the correction can be performed precisely. Accordingly, the luminance of the pixel one frame time later can be made uniform between at the time of positive polarity and at the time of negative polarity, and the difference in response speed can be resolved therebetween. Thus, the flicker and the like can be prevented from occurring on the display screen, thereby enhancing the display quality.

By using the LUT 13 that fixedly stores the correction values of the input video signal Xa in association with the combinations of the values of the input video signal Xa and the video signal Xp of the previous frame, the correction value needed for the correction for the pull-in voltage can be obtained with ease. Moreover, by using the video signal Xp of the previous frame as the reference data stored in the frame memory 12, the above-described effects can be obtained in a relatively small circuit amount.

To the liquid crystal display apparatus according to the present embodiment, various modifications can be made. For example, the LUT 13 may store different correction values in accordance with the polarity of the pixel applied voltage for all the combinations of the gradation value of the input video signal Xa and the gradation value of the video signal Xp of the previous frame, and may store different correction values in accordance with the polarity of the pixel applied voltage for a part of the combinations of the two gradation values. In this manner, the LUT 13 only needs to store the different correction values in accordance with the polarity of the pixel applied voltage for at least a part of the combinations of the values of the input video signal Xa and the video signal Xp of the previous frame. The display control unit 11 only needs to perform the different corrections in accordance with the polarity of the pixel applied voltage for at least a part of the combinations of the values of the input video signal Xa and the video signal Xp of the previous frame.

The correction values stored in the LUT 13 may be decided by a method other than the foregoing. For example, the correction values stored in the LUT 13 may be decided by experiments. In this case, the pull-in voltage may be actually measured, and the correction values may be decided so that a difference in the pull-in voltage between at the time of positive polarity and at the time of negative polarity becomes small. Moreover, in some of the combinations of the gradation value of the input video signal Xa and the gradation value of the video signal Xp of the previous frame, even if there is a difference in the pull-in voltage between at the time of positive polarity and at the time of negative polarity, the influence may not appear on the display screen. In such a case, the correction values may be decided freely within a range in which the influence does not appear on the display screen.

Moreover, the correction values stored in the LUT 13 may be the gradation values themselves of the video signal Xb after the correction, or may be differences between the gradation values of the video signal Xb after the correction and the gradation values of the input video signal Xa. In the latter case, the correction value that the display control unit 11 reads from the LUT 13 may be added to the input video signal Xa. Beside the foregoing, as the correction values stored in the LUT 13, arbitrary values that can be used when the correction for the pull-in voltage is performed to the input video signal Xa may be used. For example, the correction values stored in the LUT 13 may be the gradation values of the video signal, or may be levels of the pixel applied voltage.

Moreover, the liquid crystal display apparatus may include the data line driving circuit having a function of performing the correction for the pull-in voltage. In this case, the correction values stored in the LUT 13 may be decided in order to enable the different in response speed to be resolved between at the time of positive polarity and at the time of negative polarity, when the correction by the display control unit 11 using the LUT 13, and the correction by the data line driving circuit 15 are both performed.

### Second Embodiment

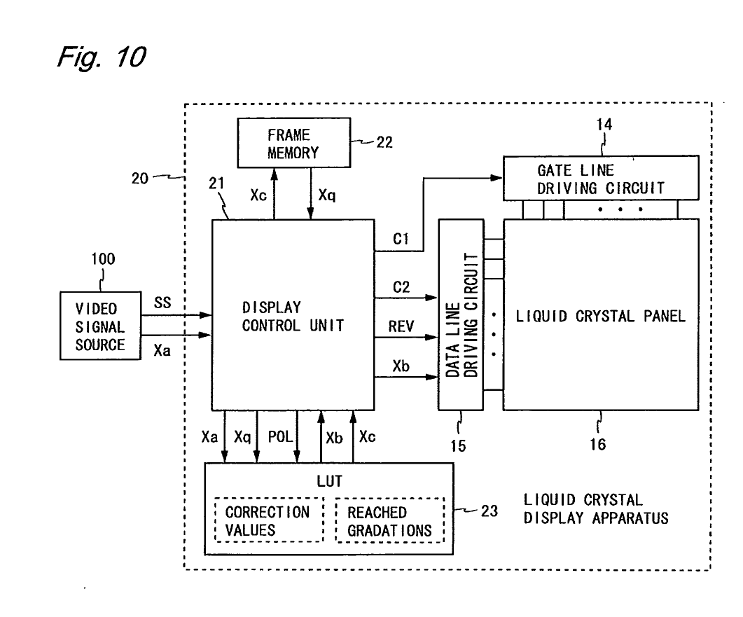

FIG. 10 is a block diagram showing a configuration of a liquid crystal display apparatus according to a second embodiment of the present invention. In a liquid crystal display apparatus 20 shown in FIG. 10, the display control unit 11, the frame memory 12 and the LUT 13 in the liquid crystal display apparatus 10 according to the first embodiment are replaced by a display control unit 21, a frame memory 22 and an LUT 23. Among components in respective embodiments described below, the same elements as those in the first embodiment will be given the same reference numerals, description of which will be omitted.

In the liquid crystal display apparatus 10 according to the first embodiment, when the response of the liquid crystal panel 16 is slow, even applying the voltage in accordance with the video signal to the pixel 3 may not allow the luminance of the pixel 3 to reach a predetermined level one frame time later. Consequently, in the liquid crystal display apparatus 20 according to the present embodiment, in place of the input video signal Xa, the frame memory 22 stores gradation of one frame, which gradation corresponds to the level that the luminance of the pixel will reach one frame time later (hereinafter, referred to as reached gradation). The display control unit 21 writes, to the frame memory 22, the reached gradation obtained for the input video signal Xa, and reads the written reached gradation one frame time later. Hereinafter, the reached gradation read from the frame memory 22 is referred to as “reached gradation Xq of a previous frame”.

The display control unit 21 outputs the input video signal Xa, the reached gradation Xq of the previous frame read from the frame memory 22, and the pixel polarity POL to the LUT 23. At this time, the correction value of the input video signal Xa and the reached gradation are read from the LUT 23. The display control unit 21 outputs the correction value read from the LUT 23 as the video signal Xb after the correction to the data line driving circuit 15, and writes, to the frame memory 22, the reached gradation read from the LUT 23 as reached gradation Xc of the current frame.

The LUT 23 fixedly stores the correction values of the input video signal Xa and the reached gradation in advance in association with combinations of the gradation value of the input video signal Xa and a value of the reached gradation Xq of the previous frame. The LUT 23 may store different correction values in accordance with the polarity of the pixel applied voltage for all the combinations of the gradation value of the input video signal Xa and the value of the reached gradation Xq of the previous frame, or may store different correction values in accordance with the polarity of the pixel applied voltage for a part of the combinations of the two values. In this manner, the LUT 23 stores the different correction values in accordance with the polarity of the pixel applied voltage for at least a part of the combinations of the values of the input video signal Xa and the reached gradation Xq of the previous frame. Using the frame memory 22 and the LUT 23, the display control unit 21 performs the different corrections in accordance with the polarity of the pixel applied voltage for at least a part of the combinations of the values of the input video signal Xa and the reached gradation Xq of the previous frame.

As described above, in the liquid crystal display apparatus 20 according to the present embodiment, the correction to compensate for the pull-in voltage is performed to the input video signal Xa as in the first embodiment. When this correction is performed, with the reached gradation Xq of the previous frame used as the reference data, the different corrections are performed in accordance with the polarity of the pixel applied voltage based on the reference data, by which the correction can be performed at high accuracy even when the response of the liquid crystal panel 16 is slow. Accordingly, a difference in response speed between at the time of positive polarity and at the time of negative polarity can be resolved at high accuracy, thereby further enhancing the display quality. Moreover, by using the table that fixedly stores the correction values relating to the input video signal Xa, and the reached gradation one frame time later, the reached gradation one frame time later needed for the correction for the pull-in voltage can be obtained with ease.

### Third Embodiment

FIG. 11 is a block diagram showing a configuration of a liquid crystal display apparatus according to a third embodiment of the present invention. In the liquid crystal display apparatus shown in FIG. 11, a frame rate conversion unit 37 is added to the liquid crystal display apparatus 10 according to the first embodiment. The frame rate conversion unit 37 performs frame rate conversion to the synchronization signal SS and the input video signal Xa output from the video signal source 100, and outputs a synchronization signal SS* after the conversion and a video signal Xa* after the conversion.

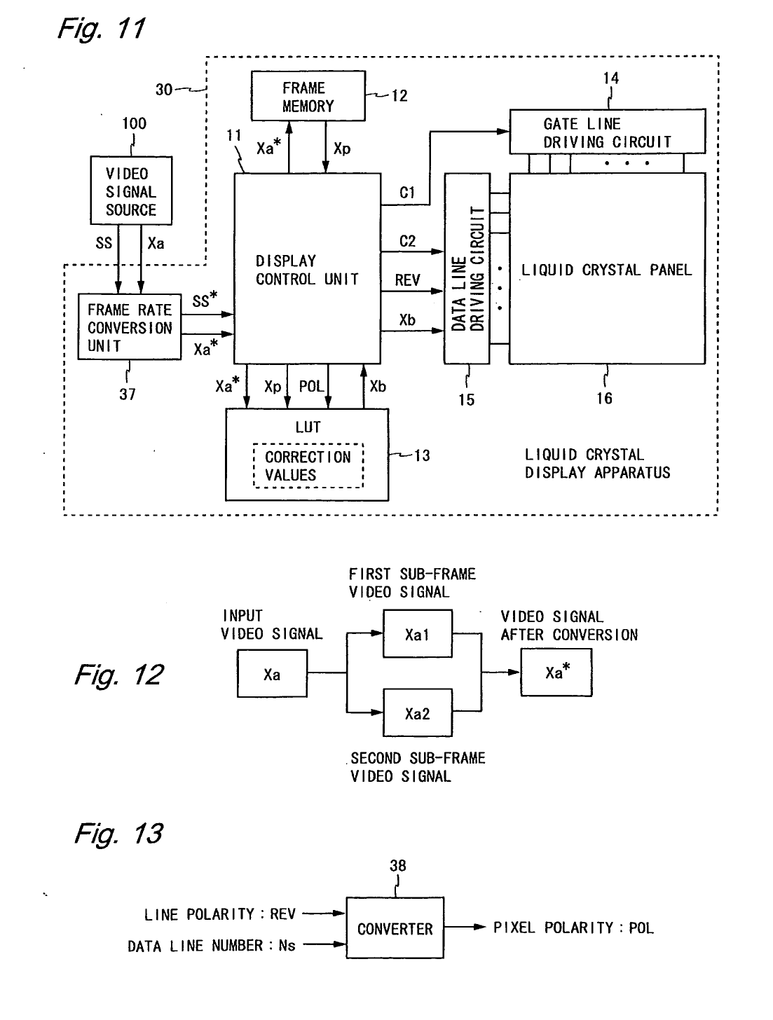

The frame rate conversion unit 37 applies the processing of generating a plurality of sub-frames based on one image to the input video signal Xa. For example, when the two sub-frames are generated based on one image, a first sub-frame video signal Xa1 and a second sub-frame video signal Xa2 are generated based on the input video signal Xa, as shown in FIG. 12. Sequentially outputting the two types of video signals Xa1, Xa2 generated results in the video signal Xa* after the conversion. The display control unit 11 performs the same operation as that in the first embodiment, based on the synchronization signal SS* after the conversion and the video signal Xa* after the conversion.

The frame rate conversion unit 37 may use an arbitrary method when the plurality of sub-frames are generated, based on one image. For example, the frame rate conversion unit 37 may copy the original image, may perform interpolation processing based on two consecutive images, or may perform processing of distributing the gradation value of the original image to the two sub-frames while giving priority to one of the sub-frames.

According to the liquid crystal display apparatus of the present embodiment, in the case where the processing of generating the plurality of sub-frames based on one image is performed, the difference in response speed between at the time of positive polarity and at the time of negative polarity can be resolved, so that the display quality can be enhanced.

### Fourth Embodiment

A liquid crystal display apparatus according to a fourth embodiment of the present invention has the same configuration (FIG. 1) as the liquid crystal display apparatus 10 according the first embodiment. The liquid crystal display apparatus according to the present embodiment is characterized in that the data line driving circuit 15 applies a voltage having the same polarity to the plurality of pixels 3 connected to the same gate line 1. In the present embodiment, the line polarity REV indicating the polarity of the pixel applied voltage on the line basis can be used as the pixel polarity POL indicating the polarity of the pixel application voltage on the pixel basis as it is.

According to the liquid crystal display apparatus of the present embodiment, as in line inversion driving, in the case where the voltage having the same polarity is applied to the plurality of pixels 3 connected to the same gate line 1, the difference in response speed between at the time of positive polarity and at the time of negative polarity can be resolved, so that the display quality can be enhanced.

### Fifth Embodiment

A liquid crystal display apparatus according to a fifth embodiment of the present invention has the same configuration (FIG. 1) as the liquid crystal display apparatus 10 according to the first embodiment. The liquid crystal display apparatus according to the present embodiment is characterized in that the data line driving circuit 15 applies a positive polarity voltage and a negative polarity voltage in a mixed manner to the plurality of pixels 3 connected to the same gate line 1. The display control unit 11 according to the present embodiment includes a converter 38 shown in FIG. 13. The converter 38 obtains the pixel polarity POL indicating the polarity of the pixel applied voltage on the pixel basis, based on the line polarity REV indicating the polarity of the pixel applied voltage on the line basis and a data line number Ns.

According to the liquid crystal display apparatus of the present embodiment, as in dot inversion driving and source line inversion driving, in the case where the positive polarity voltage and the negative polarity voltage are applied in a mixed manner to the plurality of pixels 3 connected to the same gate line 1, the difference in response speed between at the time of positive polarity and at the time of negative polarity can be resolved, so that the display quality can be enhanced.

### Sixth Embodiment

A liquid crystal display apparatus according to a sixth embodiment of the present invention has the same configuration (FIG. 1) as the liquid crystal display apparatus 10 according to the first embodiment. The liquid crystal display apparatus according to the present embodiment is characterized in that the liquid crystal panel 16 is a liquid crystal panel in the normally white mode. In the following description, applying the positive polarity voltage to perform the white display is referred to as “white display of the positive polarity”, applying the positive polarity voltage to perform the black display is referred to as “black display of the positive polarity”, applying the negative polarity voltage to perform the white display is referred to as “white display of the negative polarity”, and applying the negative polarity voltage to perform the black display is referred to as “black display of the negative polarity”.

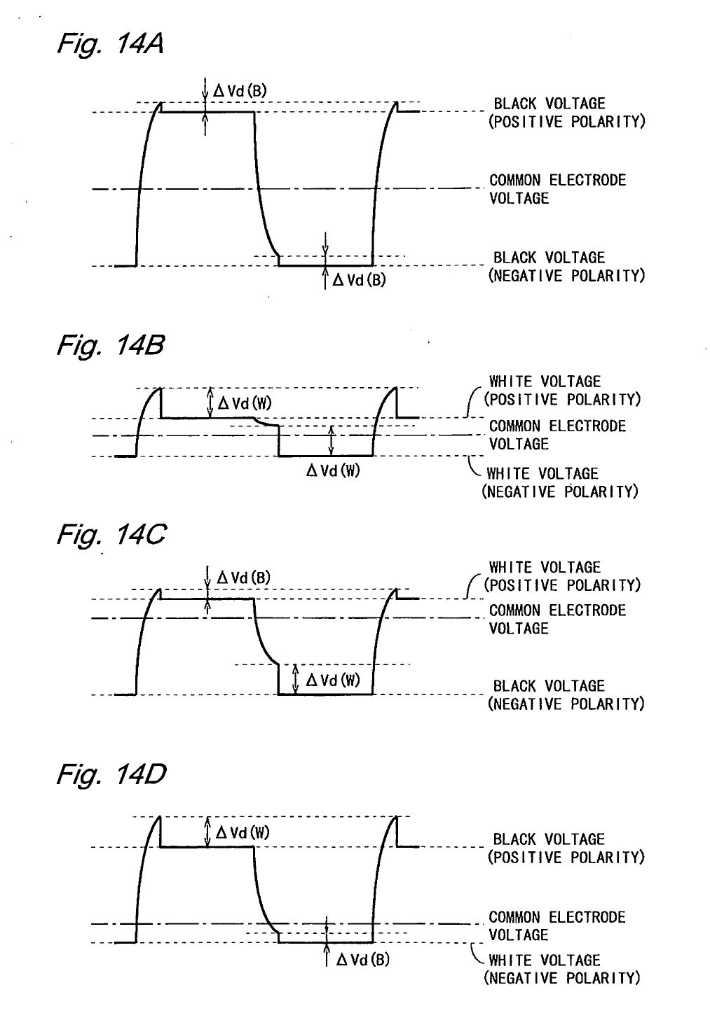

FIGS. 14A to 14D are waveform diagrams showing change of the pixel applied voltage in the liquid crystal display apparatus according to the present embodiment. In these drawings, there are shown changes of the pixel applied voltage when the black display is continuously performed (FIG. 14A), when the white display is continuously performed (FIG. 14B), when the white display of the positive polarity and the black display of the negative polarity are alternately performed (FIG. 14C), and when the black display of the positive polarity and the white display of the negative polarity are alternately performed (FIG. 14D). As shown in FIGS. 14A to 14D, in the liquid crystal panel in the normally white mode, a pull-in voltage ΔVd (W) in frame time after the white display is large, and a pull-in voltage ΔVd (B) in frame time after the black display is small.

As shown in FIG. 14C, when the white display of the positive polarity is performed after the black display of the negative polarity (a first case), the actual pull-in voltage is small, and thus, the display control unit 11 corrects the input video signal Xa so that the pixel applied voltage becomes lower than the current condition (the gradation value becomes larger). Adversely, when the black display of the negative polarity is performed after the white display of the positive polarity (a second case), the actual pull-in voltage is large, and thus, the display control unit 11 corrects the input video signal Xa so that the pixel applied voltage becomes higher than the current condition (the gradation value becomes larger).

As shown in FIG. 14D, when the black display of the positive polarity is performed after the white display of the negative polarity (a third case), the actual pull-in voltage is large, and thus, the display control unit 11 corrects the input video signal Xa so that the pixel applied voltage becomes higher than the current condition (the gradation value becomes smaller). Adversely, when the white display of the negative polarity is performed after the black display of the positive polarity (a fourth case), the actual pull-in voltage is small, and thus, the display control unit 11 corrects the input video signal Xa so that the pixel applied voltage becomes lower than the current condition (the gradation value becomes smaller).

In short, the display control unit 11 of the liquid crystal display apparatus according to the present embodiment corrects the input video signal Xa so that the pixel applied voltage becomes higher than the current condition when the absolute value of the pixel applied voltage becomes larger than that of the previous frame (the second and third cases), and so that the pixel applied voltage becomes lower than the current condition when the absolute value of the pixel applied voltage becomes smaller than that of the previous frame (the first and fourth cases). The display control unit 11 corrects the input video signal Xa so that the gradation value becomes larger at the time of positive polarity when the gradation value becomes larger (the first case), so that the gradation value becomes smaller at the time of positive polarity when the gradation value becomes smaller (the third case), so that the gradation value becomes smaller at the time of negative polarity when the gradation value becomes larger (the fourth case), and so that the gradation value becomes larger at the time of negative polarity when the gradation value becomes smaller (the second case). In other words, the display control unit 11 performs the correction to the input video signal Xa so as to change the gradation value in the same direction as the change from the previous frame at the time of positive polarity, and so as to change the gradation value in the reverse direction to the change from the previous frame at the time of negative polarity.

According to the liquid crystal display apparatus of the present embodiment, in the case where the liquid crystal panel in the normally white mode is used, when the absolute value of the pixel applied voltage becomes larger than that of the previous frame, the correction is performed to make the pixel applied voltage higher in view of the larger pull-in voltage, and when the absolute value of the pixel applied voltage becomes smaller than that of the previous frame, the correction is performed to make the pixel applied voltage lower in view of the smaller pull-in voltage, thereby enabling the correction to be performed precisely even when the input video signal changes. Moreover, when the positive polarity voltage is applied, the gradation value is changed in the same direction as the change from the previous frame, and when the negative polarity voltage is applied, the gradation value is changed in the reverse direction to the change from the previous frame, thereby enabling the correction to be performed precisely even when the input video signal changes. Accordingly, when the liquid crystal panel in the normally white mode is used, the difference in response speed between at the time of positive polarity and at the time of negative polarity can be resolved, so that the display quality can be enhanced.

### Seventh Embodiment

A liquid crystal display apparatus according to a seventh embodiment of the present invention has the same configuration (FIG. 1) as the liquid crystal display apparatus 10 according to the first embodiment. The liquid crystal display apparatus according to the present embodiment is characterized in that the liquid crystal panel 16 is a liquid crystal panel in the normally black mode.

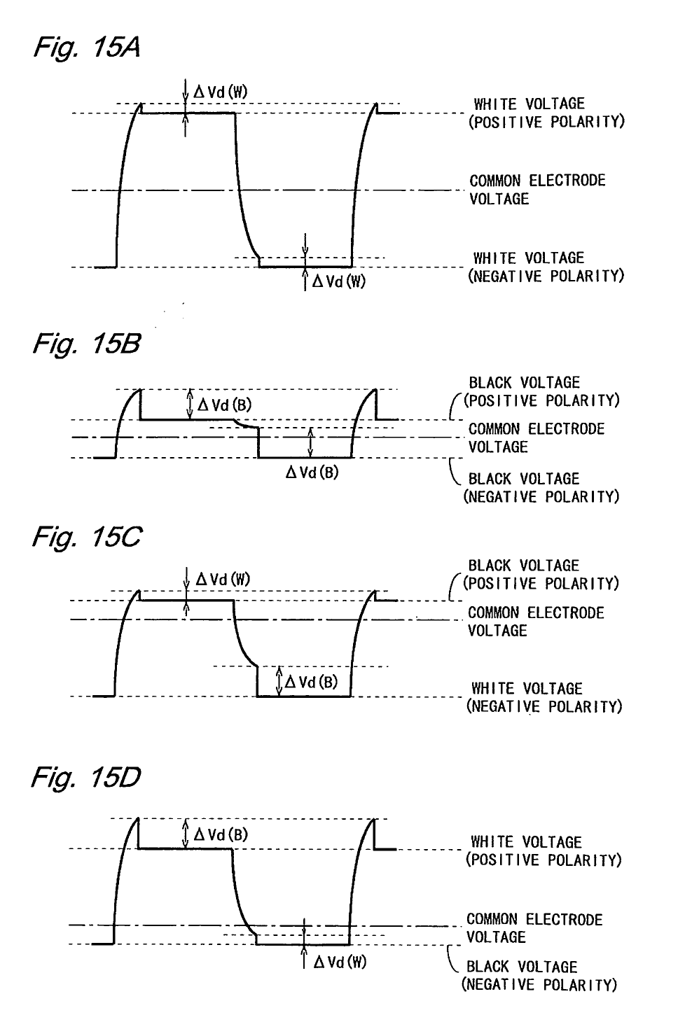

FIGS. 15A to 15D are waveform diagrams showing change of the pixel applied voltage in the liquid crystal display apparatus according to the present embodiment. In these drawings, there are shown changes of the pixel applied voltage when the white display is continuously performed (FIG. 15A), when the black display is continuously performed (FIG. 15B), when the black display of the positive polarity and the white display of the negative polarity are alternately performed (FIG. 15C), and when the white display of the positive polarity and the black display of the negative polarity are alternately performed (FIG. 15D). As shown in FIGS. 15A to 15D, in the liquid crystal panel in the normally black mode, the pull-in voltage ΔVd (B) in frame time after the black display is large, and the pull-in voltage ΔVd (W) in frame time after the white display is small.

As shown in FIG. 15C, when the black display of the positive polarity is performed after the white display of the negative polarity (a fifth case), the actual pull-in voltage is small, and thus, the display control unit 11 corrects the input video signal Xa so that the pixel applied voltage becomes lower than the current condition (the gradation value becomes smaller). Adversely, when the white display of the negative polarity is performed after the black display of the positive polarity (a sixth case), the actual pull-in voltage is large, and thus, the display control unit 11 corrects the input video signal Xa so that the pixel applied voltage becomes higher than the current condition (the gradation value becomes smaller).

As shown in FIG. 15D, when the white display of the positive polarity is performed after the black display of the negative polarity (a seventh case), the actual pull-in voltage is large, and thus, the display control unit 11 corrects the input video signal Xa so that the pixel applied voltage becomes higher than the current condition (the gradation value becomes larger). Adversely, when the black display of the negative polarity is performed after the white display of the positive polarity (an eighth case), the actual pull-in voltage is small, and thus, the display control unit 11 corrects the input video signal Xa so that the pixel applied voltage becomes lower than the current condition (the gradation value becomes larger).

In short, the display control unit 11 of the liquid crystal display apparatus according to the present embodiment corrects the input video signal Xa so that the pixel applied voltage becomes higher than the current condition when the absolute value of the pixel applied voltage becomes larger than that of the previous frame (the sixth and seventh cases), and so that the pixel applied voltage becomes lower than the current condition when the absolute value of the pixel applied voltage becomes smaller than that of the previous frame (the fifth and eighth cases). The display control unit 11 corrects the input video signal Xa so that the gradation value becomes larger at the time of positive polarity when the gradation value becomes larger (the seventh case), so that the gradation value becomes smaller at the time of positive polarity when the gradation value becomes smaller (the fifth case), so that the gradation value becomes smaller at the time of negative polarity when the gradation value becomes larger (the sixth case), and so that the gradation value becomes larger at the time of negative polarity when the gradation value becomes smaller (the eighth case). In other words, the display control unit 11 performs the correction to the input video signal Xa so as to change the gradation value in the same direction as the change from the previous frame at the time of positive polarity, and so as to change the gradation value in the reverse direction to the change from the previous frame at the time of negative polarity.

According to the liquid crystal display apparatus of the present embodiment, for a reason similar to that in the sixth embodiment, in the case where the liquid crystal panel in the normally black mode is used, the difference in response speed between at the time of positive polarity and at the time of negative polarity can be resolved, so that the display quality can be enhanced.

### Eighth Embodiment

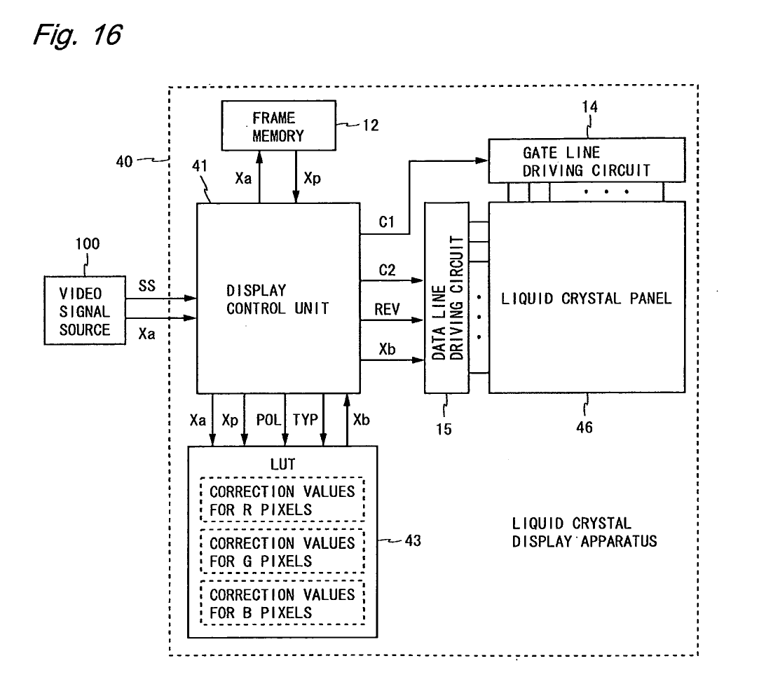

FIG. 16 is a block diagram showing a configuration of a liquid crystal display apparatus according to an eighth embodiment of the present invention. In a liquid crystal display apparatus 40 shown in FIG. 16, the display control unit 11, the LUT 13 and the liquid crystal panel 16 in the liquid crystal display apparatus according to the first embodiment are replaced by a display control unit 41, an LUT 43 and a liquid crystal panel 46. The pixels 3 in the liquid crystal panel 46 are classified into three types of R pixels to display red, G pixels to display green, and B pixels to display blue.

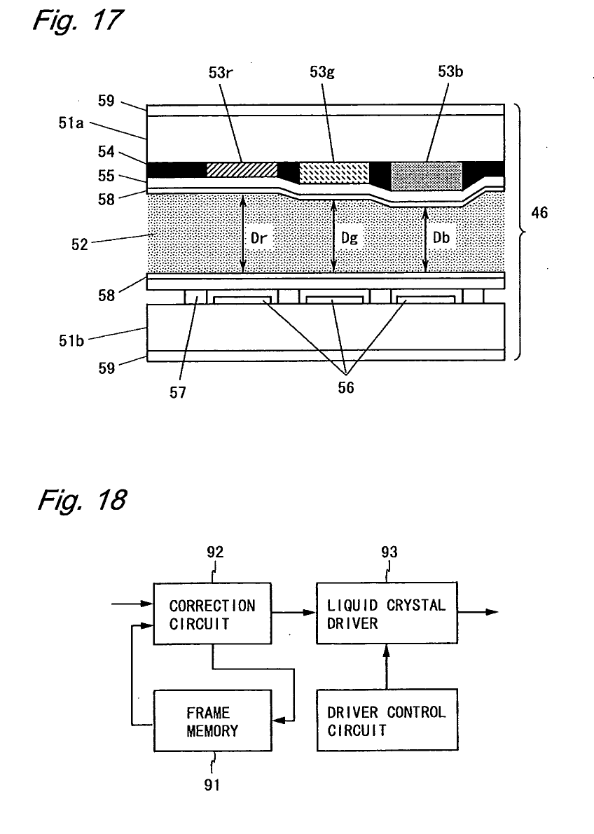

FIG. 17 is a cross-sectional view of the liquid crystal panel 46. The liquid crystal panel 46 has a structure in which a liquid crystal layer 52 is sandwiched between two glass substrates 51a, 51b. On the one glass substrate 51a, color filters 53r, 53g, 53b in three colors, a light shielding film 54, an counter electrode 55 and the like are provided, and on the other glass substrate 51b, pixel electrodes 56, data lines 57 and the like are provided. On each opposed surface of the glass substrates 51a, 51b, an alignment film 58 is provided, and on another surface thereof, a polarizing plate 59 is provided.

The R pixels, the G pixels, and the B pixels are formed at positions where the color filters 53r, 53g, 53b are provided, respectively. In FIG. 17, Dr, Dg and Db denote cell gaps of the R pixels, the G pixels, and the B pixels (thickness of the liquid crystal layer 52), respectively. When the color filters 53r, 53g, 53b differ in thickness, since the cell gap differs among the three types of pixels, the capacitance value of the liquid crystal capacitance 5 also differs among the three types of pixels.

Similar to the LUT 13 according to the first embodiment, the LUT 43 fixedly stores the correction values of the input video signal Xa in association with combinations of the gradation value of the input video signal Xa, the gradation value of the video signal Xp of the previous frame and the value of the pixel polarity POL in advance. Moreover, the LUT 43 stores different correction values in accordance with the polarity of the pixel applied voltage for at least a part of the combinations of the values of the input video signal Xa and the video signal Xp of the previous frame. Furthermore, the LUT 43 stores correction values for the R pixels, correction values for the G pixels, and correction values for the B pixels in accordance with the type of the pixel 3.

The display control unit 41, when reading the correction value of the input video signal Xa from the LUT 43, outputs a pixel type TYP indicating the type of the pixel 3, in addition to the input video signal Xa, the video signal Xp of the previous frame, and the pixel polarity POL. At this time, the correction value in accordance with the type of the pixel is read from the LUT 43. The display control unit 41 outputs the correction value read from the LUT 43 as the video signal Xb after the correction to the data line driving circuit 15. This allows the display control unit 41 to perform the different corrections in accordance with the type of the pixel 3 to the input video signal Xa.

As described above, in the liquid crystal display apparatus according to the present embodiment, the liquid crystal panel 46 includes the plurality of types of pixels 3 different in the capacitance value of the liquid crystal capacitance 5 because of different cell gaps, and the display control unit 41 performs the different corrections in accordance with the type of the pixel 3 to the input video signal Xa. In this manner, in the case where the liquid crystal panel 46 in which the capacitance values of the capacitance in the pixels 3 differ because of the different cell gaps in accordance with the type of the pixel 3 is used, the correction for the pull-in voltage is also performed, using the different correction values in accordance with the type of the pixel 3, by which the different in response speed can be resolved between at the time of positive polarity and at the time of negative polarity in all the types of pixels 3, so that the display quality can be enhanced.

While the liquid crystal panel including the plurality of types of pixels different in the cell gap is used as one example here, even when a liquid crystal panel other than the foregoing including the plurality of types of pixels (e.g., a liquid crystal panel including a plurality of types of pixels different in layout) is used, the difference in response speed between at the time of positive polarity and at the time of negative polarity can be resolved in a similar method, so that the display quality can be enhanced.

To the liquid crystal display apparatuses according to the respective embodiments of the present invention, the following modifications can be configured. For example, a plurality of correction values in accordance with temperature may be stored in the LUT, and surface temperature of the liquid crystal panel may be detected to switch the correction value output from the LUT in accordance with the detected temperature. Also, correction values to perform overshoot driving may be stored in the LUT. Moreover, characteristics of the respective embodiments may be combined arbitrarily, as long as they do not depart from its nature to configure a liquid crystal display apparatus having the characteristics of the plurality of embodiments in combination. Moreover, a display apparatus other than the liquid crystal display apparatus can be configured by the above-described method as well.

As described above, the display apparatus of the present invention performs the different corrections between at the time of positive polarity and at the time of negative polarity to the input video signal, based on the input video signal, the reference data obtained at the time of correction to the video signal of the previous frame (the video signal of the previous frame, the reached gradation of the previous frame and the like), and the polarity information of the pixel applied voltage. This enables the difference in response speed between at the time of positive polarity and at the time of negative polarity to be resolved, thereby enhancing the display quality.

### INDUSTRIAL APPLICABILITY

The display apparatus of the present invention is characterized in that the difference in response speed between when the positive polarity voltage is applied and when the negative polarity voltage is applied is small, so that the display quality is high, and it can be thus utilized as various display apparatuses such as a liquid crystal display apparatus.

### DESCRIPTION OF REFERENCE NUMERALS

3: PIXEL
4: TFT
7: PARASITIC CAPACITANCE
10, 20, 30, 40: LIQUID CRYSTAL DISPLAY APPARATUS
11, 21, 41: DISPLAY CONTROL UNIT
12, 22: FRAME MEMORY
13, 23, 43: LUT
14: GATE LINE DRIVING CIRCUIT
15: DATA LINE DRIVING CIRCUIT
16, 46: LIQUID CRYSTAL PANEL
37: FRAME RATE CONVERSION UNIT
38: CONVERTER
Xa: INPUT VIDEO SIGNAL
Xa*: VIDEO SIGNAL AFTER CONVERSION
Xb: VIDEO SIGNAL AFTER CORRECTION
Xc: REACHED GRADATION OF A CURRENT FRAME
Xp: VIDEO SIGNAL OF A PREVIOUS FRAME
Xq: REACHED GRADATION OF A PREVIOUS FRAME
POL: PIXEL POLARITY
REV: LINE POLARITY

1. A display apparatus comprising:
a display panel including a plurality of pixels each including a thin film transistor;
a correction unit that performs, to an input video signal, correction to compensate for fall of a pixel applied voltage caused by a parasitic capacitance existing between a gate and a drain of the thin film transistor;
a driving unit that applies a voltage in accordance with a video signal obtained by the correction unit to each of the pixels in the display panel while switching a polarity; and
a storage unit that stores data obtained at the time of correction to a video signal of a previous frame as reference data,
wherein the correction unit performs different corrections in accordance with the polarity of the pixel applied voltage, based on the input video signal and the reference data read from the storage unit for at least a part of combinations of both values thereof.

2. The display apparatus according to claim 1, further comprising a table that fixedly stores correction values relating to the input video signal in association with the combinations of the values of the input video signal and the reference data,
wherein the correction unit performs the correction to the input video signal, using the correction value read from the table, and
the table stores the different correction values in accordance with the polarity of the pixel applied voltage for at least a part of the combinations of the values of the input video signal and the reference data.

3. The display apparatus according to claim 2, wherein the storage unit stores the video signal of the previous frame as the reference data.

4. The display apparatus according to claim 2, wherein the storage unit stores reached gradation one frame time later as the reference data.

5. The display apparatus according to claim 4, wherein the table fixedly stores the reached gradation one frame time later in association with the combinations of the values of the input video signal and the reference data.

6. The display apparatus according to claim 1, further comprising a frame rate conversion unit that performs processing of generating a plurality of sub-frames based on one image to the input video signal, and outputs the obtained video signal to the correction unit.

7. The display apparatus according to claim 1,
wherein the display panel further includes a plurality of gate lines used for selection of the pixels, and
the driving unit applies a voltage having the same polarity to the plurality of pixels connected to the same gate line.

8. The display apparatus according to claim 1,
wherein the display panel further includes a plurality of gate lines used for selection of the pixels, and
the driving unit applies a positive polarity voltage and a negative polarity voltage in a mixed manner to the plurality of pixels connected to the same gate line.

9. The display apparatus according to claim 1,
wherein for at least a part of the combinations of the values of the input video signal and the reference data, the correction unit performs the correction to make the pixel applied voltage higher when an absolute value of the pixel applied voltage becomes larger than that of the previous frame, and to make the pixel applied voltage lower when the absolute value of the pixel applied voltage becomes smaller than that of the previous frame.

10. The display apparatus according to claim 1,
wherein for at least a part of the combinations of the values of the input video signal and the reference data, the correction unit performs the correction to change a gradation value in the same direction as change from the previous frame when a positive polarity voltage is applied, and to change the gradation value in the reverse direction to the change from the previous frame when a negative polarity voltage is applied.

11. The display apparatus according to claim 1,
wherein the display panel is a liquid crystal panel including a plurality of pixels each further including a liquid crystal capacitance and an auxiliary capacitance, the liquid crystal panel including the plurality types of pixels, in which at least one of capacitance values of the liquid crystal capacitance, the auxiliary capacitance, and the parasitic capacitance is different, and
the correction unit performs different corrections to the input video signal in accordance with the type of the pixel.

12. The display apparatus according to claim 11, wherein the display panel includes a plurality of types of pixels different in cell gap.

13. A driving method of a display apparatus having a display panel including a plurality of pixels each including a thin film transistor, the method comprising the steps of:
performing, to an input video signal, correction to compensate for fall of a pixel applied voltage caused by a parasitic capacitance existing between a gate and a drain of the thin film transistor;
applying a voltage in accordance with a corrected video signal to each of the pixels in the display panel while switching a polarity; and
storing data obtained at the time of correction to a video signal of a previous frame as reference data,
wherein in the step of performing the correction, different corrections are performed in accordance with the polarity of the pixel applied voltage, based on the input video signal and the stored reference data for at least a part of combinations of both values thereof.
